(19) United States
(12) Patent Application Publication
(10) Pub. No.: US 2003/0061751 A1
(43) Pub. Date: Apr. 3, 2003

(54) Object identification method

(76) Inventor: Martin Zoland, Melbourne (AU)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/234,526

(22) Filed: Sep. 3, 2002

(30) Foreign Application Priority Data
Sep. 4, 2001 (AU) PR 7486

(51) Int. Cl. G09F 7/12; G09F 3/10

(52) U.S. Cl. 40/638; 40/594

(57) ABSTRACT

An apparatus and method for identifying objects, particularly luggage. In various embodiments, the apparatus comprises at least one label that, when affixed to a main body portion of an object to be identified, creates a distinctive, identifying feature.

### FIELD OF THE INVENTION

The present invention relates to a device and method for identifying physical objects, and in particular to a system and method for identifying luggage items.

### BACKGROUND

A common problem for travellers using shared transport arises at the end of their journey when they need to identify their luggage in a common collection area or from a common stored area such as an airline overhead locker or a coach baggage compartment. The similar appearance of many travel bags and suitcases can make it extremely difficult to distinguish one item from another. This can be very frustrating for the traveller. One solution is to have one's name or initials permanently labelled on the bags, but the labelled areas are often small and placed on one side of the case, allowing the possibility that the monogrammed side might be facing downwards. This requires the traveller to closely inspect the bag, perhaps even removing the (often heavy) bag from a moving carousel for example. The same difficulty arises when tags are tied around the handle of the bag. Perhaps the best prior art solution is a coloured belt for tying around suitcases, but this method requires the traveller to keep track of the belt, which must be unfastened from the suitcase when the suitcase is opened, and can also lead to confusion when several travellers have belts of the same colour on their suitcases. It is desired, therefore, to provide a low cost method for easily and rapidly identifying luggage or other objects, or at least to provide a useful alternative.

### SUMMARY OF THE INVENTION

In accordance with the present invention there is provided a method for identifying a physical object by affixing to said object a number of labels to form a distinctive, identifying visual feature.

Advantageously, a number of different label types may be provided, where each of said types has distinctive visual characteristics which differentiate it from the others.

Advantageously, said distinctive visual characteristics may include differences in shape. The distinctive visual characteristics may also or alternatively include differences in colour, reflectivity or texture and/or the inclusion of holographic elements or printed material.

Preferably, said labels are self adhesive, so that said labels may be easily affixed to said object. The labels may be provided in a single sheet with different shapes. The labels of the sheet may be the same colour.

The present invention also provides labels for attaching to a physical object in order to identify said object by forming one or more distinctive, identifying visual features.

The present invention also provides an object with one or more distinctive, identifying visual features formed by attaching a number of labels to said object.

Advantageously the objects may be luggage.

The present invention also provides luggage having identifying elements including labels arranged in a distinctive manner on said luggage. The labels may be part of a set of labels where each label has a different appearance. The different appearance may be dictated by shape, colour, texture, material, reflectivity and/or the inclusion of holographic features.

The present invention also provides a luggage identification device comprising a set of labels of different appearance. The labels may be self adhesive labels. The labels may be on a single sheet. The labels may be of the same colour on each sheet.

### BRIEF DESCRIPTION OF THE DRAWINGS

Preferred embodiments of the present invention are hereinafter described, by way of example only, with reference to the accompanying drawings, wherein:

FIG. 1 illustrates various simple shapes of a preferred embodiment of an object identification device;.

FIG. 2 is a representation of a sheet of adhesive labels of a preferred embodiment of an object identification device;

FIG. 3 is a first illustration of a suitcase identified by a preferred embodiment of an object identification device;

FIG. 4 is a second illustration of a suitcase identified by a preferred embodiment of an object identification device; and

FIG. 5 illustrates various complex shapes of a preferred embodiment of an object identification device.

### DETAILED DESCRIPTION OF THE PREFERRED EMBODIMENT

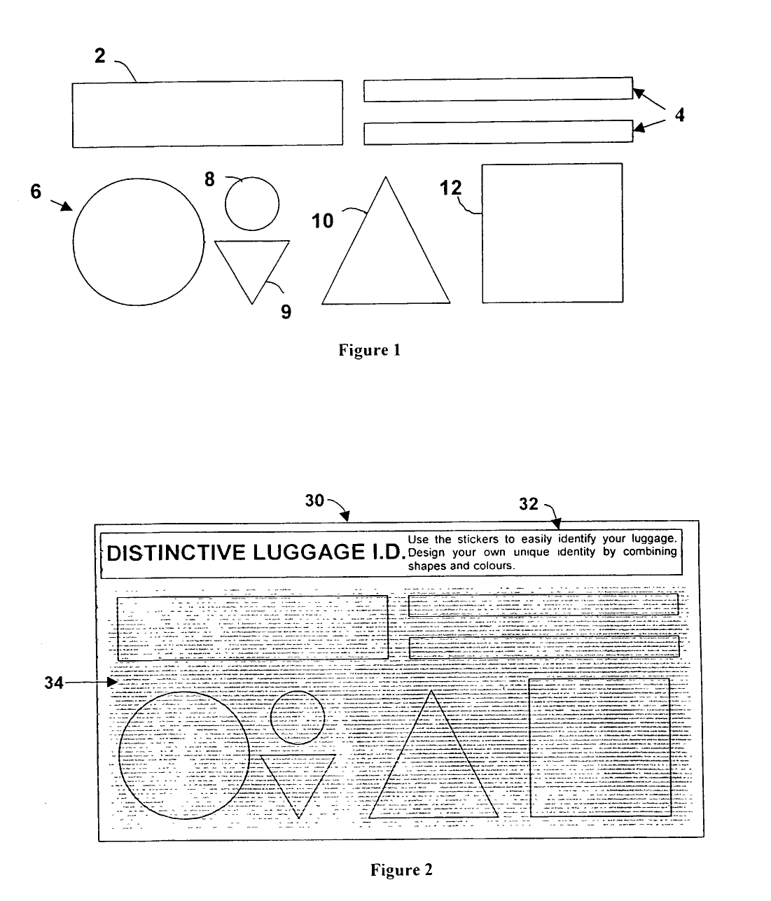

A method of identifying physical objects is described below which involves using an identification device having a number of elements which are labels. The labels have different shapes such as those shown in FIG. 1, including rectangles 2, 4, circles 6, 8, triangles 9, 10 and squares 12 of various sizes which are easily distinguished from each other. By affixing a number of such labels in a visually distinctive arrangement to one or more objects in a group of visually similar objects, those objects can be readily identified from the group. This has particular utility in situations where a person leaves one or more objects for some period of time amongst visually similar objects, and then either that person or some other person must identify their object(s) from the group at some later time. This situation is familiar to people who travel with luggage using some form of shared transport, in particular air travel, but the same need may arise with bus, train, or sea travel. The problem arises because most travel bags or suitcases are visually similar, making it difficult to distinguish one item from another, particularly when those items are on a moving platform of some sort, as is the case in modern airports. The same problem arises when retrieving hand luggage from a shared locker or compartment of a coach. A simple solution to this problem is to use labels such as those illustrated in FIG. 1.

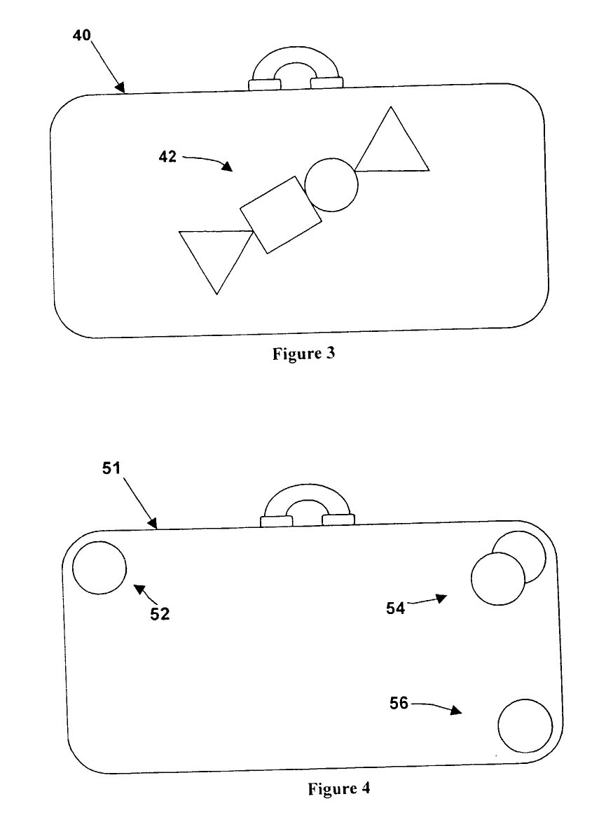

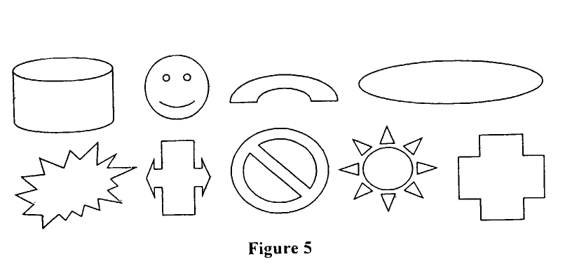

A person wishing to travel by airplane or by other means of transport arrives at an airport or departure point with their suitcase. They register at the check-in counter, and are given several sheets of adhesive labels or ‘stickers’, such as the sheet 30 shown in FIG. 2. The sheet 30 contains a coloured area 34 containing the labels and a text area 32 which includes usage instructions. Each sheet is a different colour or each sheet contains labels or stickers of different colours. The traveller peels off some of the stickers from each sheet and attaches them to each side of the suitcase in a distinctive pattern. The ‘pattern’ could be as simple as a single shape at some particular location on the suitcase, but the same configuration could be used by another traveller. FIG. 3 shows a suitcase 40 with a distinctive composite shape 42 formed by four labels. The labels do not have to be together and FIG. 4 shows a suitcase 51 with three groups of labels 52, 54 and 56, which together form a distinctive arrangement. The arrangements may, of course, be arbitrarily complex, the importance lying in the uniqueness of the visual appearance and the ease by which it may be distinguished from other arrangements of labels.

After arriving at the destination, the traveller goes to the baggage carousel, or retrieves luggage from an overhead locker or baggage compartment of a plane or coach, and easily identifies the suitcase labelled with the distinct arrangement of coloured shapes from a number of otherwise visually similar suitcases. Because each traveller designs their own composite shape(s) and/or arrangements of labels, each traveller can quickly identify their own luggage, even if a number of bags have their own arrangements of the same labels. For example, the suitcases 40 and 51 shown in FIGS. 3 and 4 are easily distinguished.

The labels do not have to be simple shapes like those shown in FIG. 1. For example, FIG. 5 shows some more complex shapes which might facilitate identification. Furthermore, any feature which gives the labels a distinctive visual appearance may be used, including colour, texture, material, reflectivity or patterns of these elements within a single shape. With regard to texture, it may be useful to include raised or embossed features within a label, however, these features should be designed to reduce the risk of shearing the labels from the object.

Many modifications will be apparent to those skilled in the art without departing from the scope of the present invention as hereinbefore described with reference to the accompanying drawings.

I claim:

1. An apparatus for identifying objects comprising:
at least one label that, when affixed to a main body portion of an object to be identified, creates a distinctive, identifying feature.

2. The apparatus of claim 1, wherein the label comprises:
a self-adhesive backing.

3. The apparatus of claim 1, wherein the label has identifiable characteristics.

4. The apparatus of claim 3, wherein the identifiable characteristics comprise:
at least one of shape, color, reflectivity, holographic images, printed material, and texture.

5. The apparatus of claim 1, wherein the object to be identified is luggage.

6. An apparatus for identifying objects comprising:
a sheet; and
at least one self-adhesive label removably attached to the sheet, such that when the label is affixed to a main body portion of an object to be identified, a distinctive, identifying feature is created.

7. The apparatus of claim 6, wherein a plurality of labels are attached to the sheet and the plurality of labels are of the same color.

8. The apparatus of claim 6, wherein the label has identifiable characteristics.

9. The apparatus of claim 8, wherein the identifiable characteristics comprise:
at least one of shape, color, reflectivity, holographic images, printed material, and texture.

10. The apparatus of claim 6, wherein the object to be identified is luggage.

11. A method for identifying a physical object comprising:
aligning at least one label in a pattern relative to a main body portion of the physical object; and
affixing the label to the main body portion of the physical object according to the pattern to create a distinctive, identifying feature.
